(19) United States
(12) Patent Application Publication
(10) Pub. No.: US 2021/0377385 A1
(43) Pub. Date: Dec. 2, 2021

(54) MANAGING USER-INTERFACE PARAMETER FOR MOBILE DEVICE

(71) Applicant: Micron Technology, Inc., Boise, ID (US)

(72) Inventors: Claudia A. Delaney, Garden City, ID (US); Bhumika Chhabra, Boise, ID (US); Madison E. Wale, Boise, ID (US); Elsie de la Garza Villarreal, Nampa, ID (US)

(21) Appl. No.: 16/886,632

(22) Filed: May 28, 2020

(51) Int. Cl. H04M 1/725

(52) U.S. Cl. CPC H04M 1/72572; H04M 1/72597; H04M 1/72577; H04M 1/72569

(57) ABSTRACT

Methods and apparatuses for managing user-interface parameters for mobile devices are described. The mobile device may determine whether a user-interface parameter is set to an appropriate value, based on various user-predefined conditions. In some cases, the mobile device may determine that a user-predefined condition satisfies a threshold and set the user-interface parameter to a different value from a current value. In some cases, the mobile device may notify the user that the user-defined condition has satisfied the threshold and prompt the user to confirm setting the user-interface parameter to the different value. In some cases, the mobile device may set the user-interface parameter based on its location determined by a GPS. In this manner, the mobile device may reduce risks of incoming calls for the user going unnoticed, due to inadequate settings of the user-interface parameters.

### TECHNICAL FIELD

The present disclosure generally relates to mobile devices, and more particularly relates to managing user-interface parameters for mobile devices.

### BACKGROUND

Mobile devices (e.g., cellular phones, mobile phones, tablets, etc.) are widely deployed to help users in various environments. Such mobile devices are equipped with audio-settings that support users of the mobile device, for example, providing notices of incoming calls and/or messages, generating sounds for multimedia contents, or the like. The users may temporarily modify the audio settings in different environments to avoid disturbing other people. For example, a user may mute a ringtone volume of his/her cell phone in a quiet environment—e.g., in a library. Thereafter, the user may forget to reset the ringtone volume, and miss important phone calls or messages as a result. Similarly, the user may increase the ringtone volume in a noisy environment—e.g., a shopping mall, and forget to reduce the volume, which may create an embarrassing situation for the user when the loud ringtone later alerts in a less noisy environment.

### BRIEF DESCRIPTION OF THE DRAWINGS

FIG. 1 is a schematic diagram illustrating various environments for managing user-interface parameters for mobile devices in accordance with embodiments of the present technology.

FIG. 2 is an example screen of a mobile device that supports managing user-interface parameters in accordance with embodiments of the present technology.

FIG. 3 is a block diagram of a mobile device that supports managing user-interface parameters in accordance with embodiments of the present technology.

FIGS. 4 and 5 are flowcharts of methods of managing user-interface parameters for mobile devices in accordance with embodiments of the present technology.

The techniques introduced here may be better understood by referring to the following Detailed Description in conjunction with the accompanying drawings, in which like reference numerals indicate identical or functionally similar elements.

### DETAILED DESCRIPTION

Mobile devices (e.g., cellular phones) are ubiquitous in contemporary lifestyle, assisting users of the mobile devices in various business and/or personal settings. A useful function of the mobile devices is to keep the users connected with their contacts, e.g., via phone calls and/or text messages. To that end, the mobile device typically includes various user-interface parameters configured to notify the users of incoming calls (or text messages, emails, etc.). Such user-interface parameters of the mobile device may include a volume level, a vibration mode, a brightness level of a screen, a size of letters displayed on the screen, or the like. In some cases, such user-interface parameters may be part of operating conditions of the mobile device.

The users may set certain user-interface parameters (e.g., audio parameters, ringtone volumes) to convenient levels for them depending on their needs and/or different environments. For example, a user may experience hearing impairment challenges and set a volume level of his/her cellular phone high enough for the user, for example, when the user is at home, such that the user can easily hear a ringtone of an incoming call. Additionally, the user may configure a vibration mode or an illumination alert mode of the cellular phone such that the user may notice the vibration or several camera flashes of the cellular phone as well, upon receiving the incoming call.

The user-interface parameters set by the user in certain environments (e.g., at home), however, may be inappropriate in other environments (e.g., in a library, at a funeral service, etc.). As such, the user may temporarily set the user-interface parameters to different levels. For example, the user with hearing challenges may set the volume level to a reduced level or mute ringtone volumes. In some instances, however, the user may forget to restore the previous settings of the user-interface parameters when the user no longer needs to operate the cellular phone with the user-interface parameters set at the temporary levels—e.g., returning to home after visiting the library. As a result, the user may miss an important call or have a text message unattended, which in turn, may cause inconveniences for the user, as well as the user's contacts (e.g., family members, friends, co-workers, etc.).

Embodiments of the present technology may facilitate a mobile device to determine whether a user-interface parameter is set to a value appropriate for a user of the mobile device. In some cases, the user may have stored the value in the mobile device. Additionally, or alternatively, the mobile device may have stored the value after determining that the user has set the user-interface parameter to the value. The mobile device may make such determination based on various predefined conditions that the user has provided (“user-predefined condition”). In some cases, the mobile device may set the user-interface parameter to a different value from a current value, after determining that a user-predefined condition satisfies a threshold. In other cases, the mobile device may notify the user that the user-defined condition has satisfied the threshold. Thereafter, the mobile device may prompt the user to confirm setting the user-interface parameter to the different value, in some cases.

Such a mobile device may include a memory to store a first value for the user-interface parameter provided (and/or set) by the user. In some cases, the first value may be a default value for the user-interface parameter. As described herein, the user-interface parameter is configured to notify an incoming call (or a message) to the user, for example, a volume level, a vibration mode, a brightness level of a screen, a size of letters displayed on the screen, or a combination thereof. The first value may be associated with a certain environment for the user—e.g., at home.

Afterward, the user may set the user-interface parameter to a second value (e.g., a temporary value) that is different from the first value. Further, the user may provide a user-predefined condition associated with using the second value for the user-interface parameter. The user-defined condition may be related to a different environment for the user (e.g., at work, at a movie theater, etc.) and/or other circumstances, such as a present location (or geolocation) of the mobile device, a duration (or an elapsed time) after setting the user-interface parameter to the second value, a predetermined quantity of calls from a particular phone number stored in the mobile device, a future time of a day, or a combination thereof. Accordingly, the mobile device may determine whether the user-predefined condition is satisfied or not, such that the mobile device may set the user-interface parameter to a third value if the user-predefined condition is satisfied.

In an embodiment, the third value may correspond to the first value; namely, the mobile device may revert the user-interface parameter back to the default value after the user-predefined condition is met. In another embodiment, the third value may correspond to the second value; namely, the mobile device may continue to maintain the user-interface parameter at the second value, after determining that the user-predefined condition is met. In such an embodiment, the mobile device may notify the user that the user-predefined condition has been satisfied. Further, the mobile device may prompt the user to set the user-interface parameter to its default value and/or notify the user that the user-interface parameter is set to the second value. In some cases, the user may have specified a duration during which the user wants the mobile device not to operate with the user-interface parameters set at the default value (e.g., the first value). Accordingly, the mobile device may continue to maintain the user-interface parameter at the second value (i.e., the third value corresponding to the second value) after the user-predefined condition is met, when the present date and time is within the duration. In yet another embodiment, the third value may be different from both the first value and the second value, for example, an intermediate value between the first and second values.

In some embodiments, the mobile device may set the user-interface parameter to different values based on its geographic location (geolocation), which may be determined using a global positioning system (GPS) coupled with the mobile device, in some cases. For example, the user may provide a first value for the user-interface parameter and a first reference location associated with the first value. If the mobile device determines that the mobile device is in a first area within a first radial distance from the first reference location, based on a present geolocation of the mobile device determined by the GPS, the mobile device may set the user-interface parameter to the first value, after determining that the mobile device is in the first area. In some cases, the mobile device may prompt the user, prior to setting the user-interface parameter to the first value, whether to set the user-interface parameter to the first value.

Further, if the user sets the user-interface parameter to a second value (different from the first value) when the user is at a second location (different from the first location), the mobile device may store the second value for the user-interface parameter, as well as the second location as a second reference location associated with the second value. In this manner, when the mobile device determines, in the future, that the mobile device is in a second area within a second radial distance from the second reference location, the mobile device can set the user-interface parameter to the second value (or prompt the user whether to set the user-interface parameter to the second value), after determining that the mobile device is in the second area.

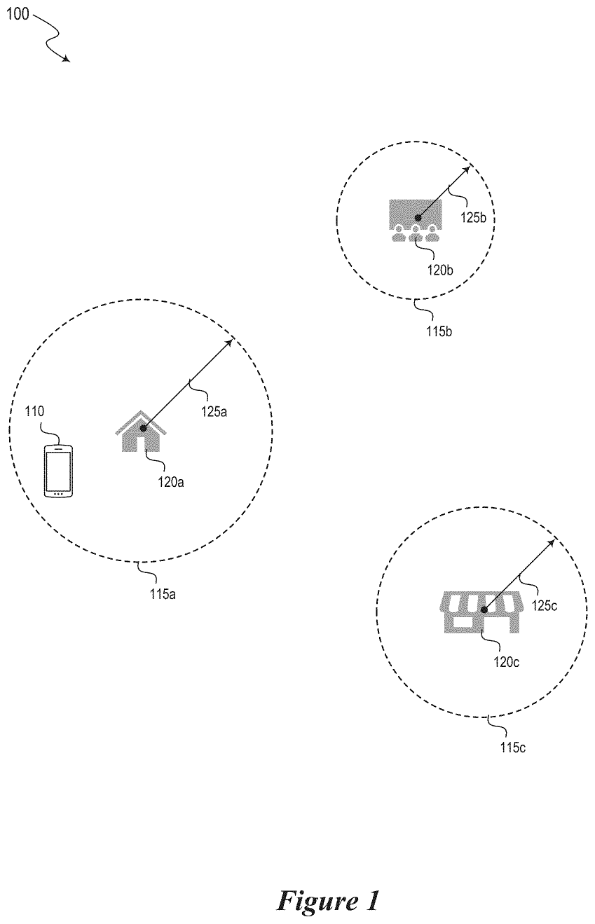

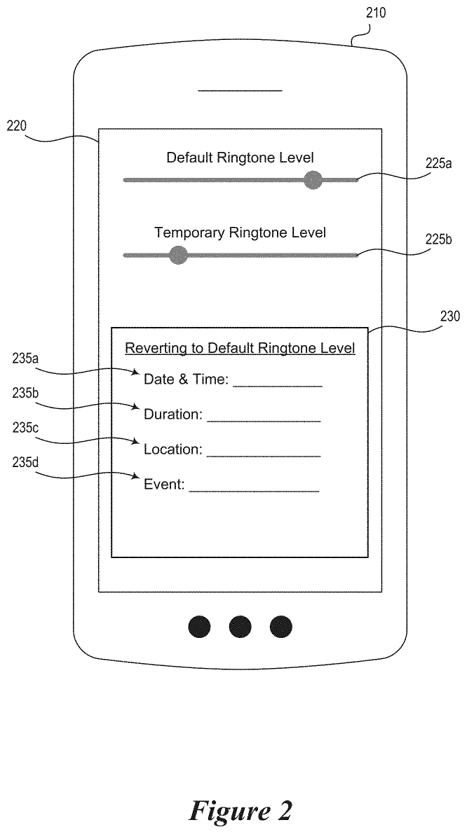

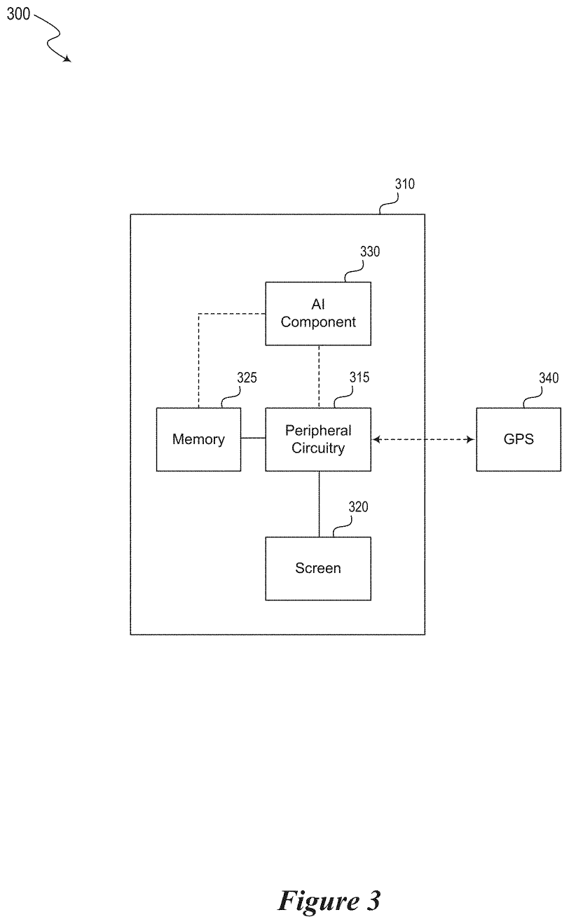

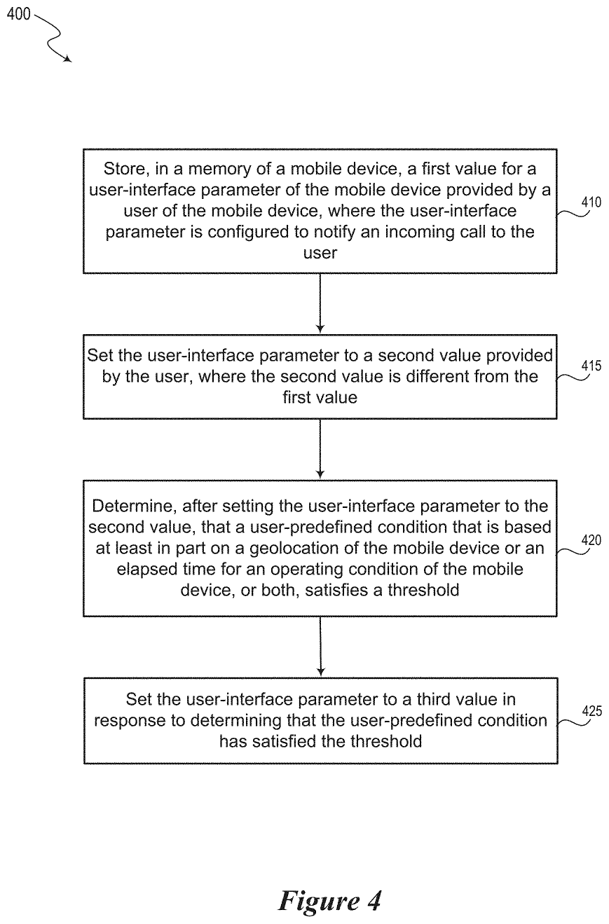

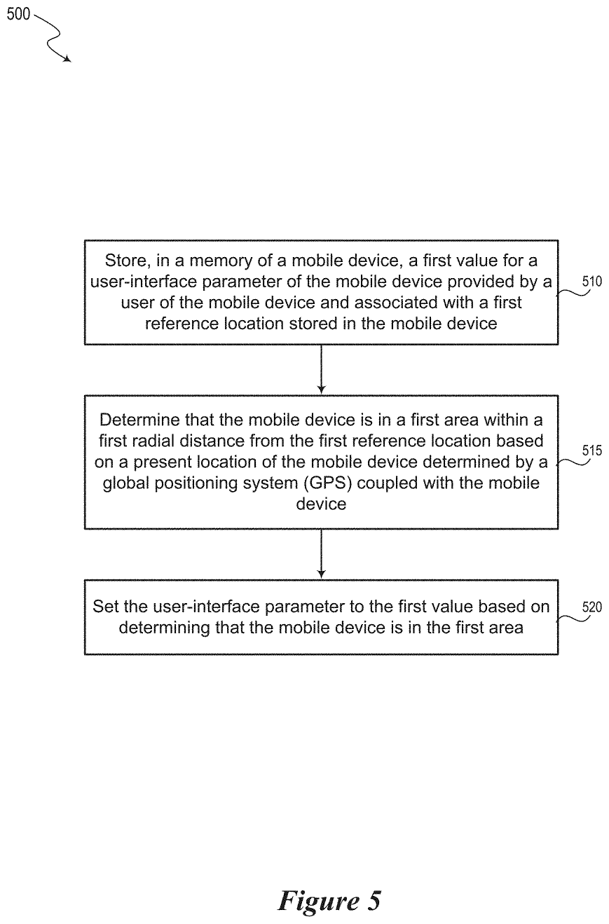

Various environments for managing user-interface parameters for mobile devices in accordance with embodiments of the present technology are illustrated in FIG. 1. An example screen of a mobile device in accordance with embodiments of the present technology is described with reference to FIG. 2. Detailed descriptions of a mobile device that supports managing user-interface parameters in accordance with embodiments of the present technology are provided with reference to FIG. 3. Flowcharts illustrating methods of managing user-interface parameters for mobile devices in accordance with embodiments of the present technology are described with reference to FIGS. 4 and 5.

FIG. 1 is a schematic diagram 100 illustrating various environments for managing user-interface parameters for mobile devices in accordance with embodiments of the present technology. The schematic diagram 100 includes a mobile device 110 of a user and several geographic areas 115 (also identified individually as areas 115a through 115c) where the mobile device 110 (e.g., the user of the mobile device 110) may be located. Individual areas 115 include corresponding reference locations 120 (also identified individually as reference locations 120a through 120c), as well as radial distances 125 (also identified individually as radial distances 125a through 125c). In this example diagram 100, the reference locations 120a through 120c may represent the user's home, a movie theater, and a grocery store, respectively, for illustration purposes only.

The mobile device 110 may be coupled with a GPS such that the mobile device 110 can determine its present geographical location. Further, the mobile device 110 may include various user-interface parameters configured to notify an incoming call (and/or incoming messages, emails, etc.) to the user. The user-interface parameters may include a volume level of the mobile device, a vibration mode of the mobile device, a brightness level of a screen of the mobile device, a size of letters displayed on the screen, or a combination thereof.

The user may store a set of values for each user-interface parameter, where individual values of the set may be associated with different environments. Different environments may be based on a current location of the mobile device 110—e.g., whether the mobile device 110 is at home (e.g., the area 115a) or at a movie theater (e.g., the area 115b), a present time of a day (e.g., 9 PM on Saturday, 10 AM on Monday, etc.), or the like. For example, the user may set a ringtone volume of the mobile device 110 at a high level when the user is at home (e.g., the area 115a including the reference location 120a) if the user is challenged with hearing impairment issues. In some cases, the user may store the ringtone volume that has been set at the high level as a default value (e.g., a first value) for the mobile device 110. Further, the user may store GPS coordinates corresponding to the user's home as a first reference location 120a associated with the default value for the ringtone volume.

Additionally, or alternatively, the mobile device 110 may determine that the user has set a user-interface parameter to a certain value when the user is at a certain location. Subsequently, the mobile device 110 may store the value, to which the user has set the user-interface parameter, as well as information associated with the user-interface parameter setting, such as the corresponding location (e.g., GPS coordinates) as a reference location, the time and/or the day, the duration that the user maintained the setting, or the like. In this manner, the mobile device 110 may maintain and/or update the set of values for the user-interface parameter, as well as various information associated with individual values of the set—e.g., information regarding geographical locations, times and/or days, duration, etc.

In some cases, a default value the user has set for a user-interface parameter may be inappropriate when the user moves to a different environment. Accordingly, the user may set certain user-interface parameters to different values suitable for the different environment. For example, the user may set the ringtone volume of the mobile device 110 to a low level (or a silence mode) when the user goes to the movie theater (e.g., in the area 115b including the reference location 120b).

As described herein, the user may store the ringtone volume that has been set at the low level (e.g., a second value) in the mobile device 110. Further, the user may store GPS coordinates corresponding to the movie theater as a second reference location 120b associated with the second value for the ringtone volume. Additionally, or alternatively, the mobile device 110 may determine that the user has set the ringtone volume to a different value (e.g., the second value different from the first value) when the user is at a different location (e.g., the movie theater different from the user's home), and store the value that the user has used for the ringtone volume (e.g., the second value), as well as the corresponding location (e.g., the GPS coordinates of the movie theater) as a second reference location 120b associated with the second value. In some cases, the mobile device 110 may store additional information related to the second value for the ringtone volume, such as the time and/or the day of setting the second value, the duration of using the second value, etc.

In some embodiments, the mobile device 110 may prompt the user to provide one or more conditions (e.g., user-predefined conditions) when the user changes (or provides) a value of the user-interface parameter (or when the mobile device 110 determines as such). The user-predefined conditions may be associated with conditions (or environments) for maintaining the user-interface parameter at the value that the user provided (or conditions for stopping to maintain the user-interface parameter at the value). For example, the user-predefined conditions may relate to one or more geolocations (e.g., using the second value for the ringtone volume while the mobile device 110 is in the area 115b including the reference location 120b, using the first value for the ringtone volume when the mobile device 110 determines its location within the area 115a including the reference location 120a), a duration or an elapsed time for the user-interface parameter since the user-interface parameter has been set to a certain value (e.g., using the second value for the ringtone volume for three (3) hours, diverting the ringtone volume to the first value after three (3) hours), a future time of a day (e.g., using the second value for the ringtone volume until the future time, diverting the ringtone volume to the first value on or after the future time), or the like.

Afterward, the mobile device 110 may monitor the user-predefined condition to determine whether the user-predefined condition is satisfied. If the mobile device 110 determines that the user-predefined condition is satisfied, the mobile device 110 may notify the user that the user-predefined condition has been satisfied. In some cases, the mobile device 110 may notify the user that the user-interface parameter (e.g., the ringtone volume) has been set to the second value (e.g., a different value than the default value). Further, the mobile device 110 may inquire the user whether the user prefers to maintain the user-interface parameter at the second value or change to a different value (e.g., the default value, a third value different from both the first and second values).

In some embodiments, after determining that the user-predefined condition is satisfied, the mobile device 110 may set the user-interface parameter to a third value. In some cases, the mobile device 110 may set the user-interface parameter to the third value without inquiring the user as to what the user wants for the user-interface parameter setting. Instead of inquiring the user, the mobile device 110 may notify the user that the user-interface parameter is set to the third value and/or that the user-predefined condition has been satisfied. Moreover, the mobile device 110 may repeat such notifications in a more conspicuous manner. In some cases, the mobile device 110 may generate a verbal message to the mobile device 110 to notify the user. Moreover, the mobile device 110 may repeat the verbal message with an increased volume. In some cases, the mobile device 110 may transmit a text message to the mobile device 110 to notify the user. Moreover, the mobile device 110 may repeat the text message with an increased letter size and/or in a different font. In some cases, the mobile device 110 may display a pop-up window on a screen of the mobile device 110 to notify the user. Moreover, the mobile device 110 may repeat the pop-up window with an increased brightness, in different colors, in different sizes and/or shapes, or the like.

In some cases, the third value may be equal to the first value (e.g., the default value); namely, the mobile device 110 reverts the user-interface parameter back to the default value. In some cases, the third value may be equal to the second value; namely, the mobile device 110 maintains the user-interface parameter at the second value after the user-predefined condition is satisfied. In some cases, the third value may be different from both the first and second values.

In some embodiments, the mobile device 110 may set a user-interface parameter to different values based on determining that the mobile device 110 is in different locations (geolocations). In this regard, the mobile device 110 may store a set of values for a user-interface parameter, where individual values of the set are associated with corresponding reference locations (which may be determined by the GPS, in some cases). By way of example, the mobile device 110 may store, in a memory of the mobile device 110, a first value (e.g., a default value) for a user-interface parameter (e.g., a ringtone volume associated with an incoming call) of the mobile device 110. In some cases, the first value may be provided by the user—e.g., the user sets the ringtone volume at a high value and store the high value as a default value for the ringtone volume for the mobile device 110. In some cases, the mobile device 110 may determine that the user sets the user-interface parameter at the first value and store the first value. Further, the mobile device 110 may store a first reference location (e.g., the reference location 120a, the user's home) associated with the first value. Similarly, the mobile device 110 may store a second value for the user-interface parameter and a second reference location (e.g., the reference location 120b, the movie theater) associated with the second value—e.g., the user sets the ringtone volume to a low value (or in a silence mode) when the user is at the movie theater.

Once the mobile device 110 stores one or more values for the user-interface parameter and one or more corresponding reference locations associated with the one or more values, the mobile device 110 may set the user-interface parameter to a particular value stored in the mobile device 110 based on determining that the mobile device 110 is in an area including a particular reference location store in the mobile device 110. For example, the mobile device 110 determines that the mobile device 110 is in a first area (e.g., the area 115a) within a first radial distance (e.g., the radial distance 125a) from the first reference location (e.g., the reference location 120a) based on a present location of the mobile device 110 determined by the GPS. Subsequently, the mobile device 110 may set the user-interface parameter to the first value based on determining that the mobile device is in the first area. Similarly, if the mobile device 110 determines that the mobile device 110 is in a second area (e.g., the area 115b) including the second reference location (e.g., the reference location 120b), the mobile device 110 may set the user-interface parameter to the second value based on determining that the mobile device 110 is in the second area.

In some cases, after determining that the mobile device is in the first area, the mobile device 110 may prompt the user whether to set the user-interface parameter to the first value before setting the user-interface parameter to the first value. In some cases, the mobile device 110 may determine, prior to prompting the user, that the user-interface parameter has been set to the second value different than the first value, where the second value has been provided by the user and associated with the second reference location—e.g., the user may have been in the area 115b watching a movie at the movie theater (e.g., the reference location 120b) and set the ringtone volume of the mobile device 110 to the second value while in the area 115b. In some cases, the mobile device 110 may notify, prior to prompting the user, the user that the mobile device 110 is in the first area (e.g., the area 115a) based on determining that the mobile device is in the first area, and/or that the first value (e.g., the default value) is available for the user-interface parameter. In this manner, even if the user may have forgotten to reset the ringtone volume to the first value (e.g., the default value), the mobile device 110 can set the ringtone volume to the first value after determining that the user is in the first area (e.g., the user returns home after watching a movie at the movie theater) with or without the user's confirmation.

In some embodiments, the mobile device 110 may add new values for the user-interface parameter, as well as new reference locations associated the new values. For example, the mobile device 110 may determine, after setting the user-interface parameter to the first value, that the mobile device 110 has moved to a third location different from the present location—e.g., the user visits a newly-opened grocery store that the user never visited before, after having returned home from the movie theater. Subsequently, the mobile device 110 may determine that the user has set the user-interface parameter (e.g., the ringtone volume) to a third value different from the first and/or the second value—e.g., the user determines to reduce the ringtone volume from the default value while in the grocery store. The mobile device 110 may store the third value and the location of the grocery store (e.g., GPS coordinates of the grocery store) as a third reference location in the memory. Accordingly, the mobile device 110 may set the user-interface parameter to the third value when the user visits the grocery store next time (or inform the user that the third value is available for the user to use).

In some cases, the mobile device 110 may delete one or more values for the user-interface parameter (and associated reference locations) based on the user's pattern of usage. For example, the user may have moved to a different place (e.g., a different county or state) and never (or seldomly) visit where the user used to live. Then, the mobile device 110 may delete one or more reference locations where the user no longer (or seldomly) visits, as well as associated values for the user-interface parameter. In this manner, the mobile device 110 may store and/or maintain multiple values for the user-interface parameter that each are associated with corresponding reference locations such that the mobile device 110 can assist the user to use an appropriate value for the user-interface parameter depending on where the user is—e.g., the library mode, the theater mode, the grocery store mode.

In some embodiments, the user may provide values for the radial distances (e.g., the radial distances 125a through 125c) for the mobile device 110 to use to determine whether the mobile device 110 is within a certain area (e.g., one of areas 115a through 115c). In some cases, the radial distances may be different from each other. In other cases, two or more radial distances may be identical.

In some embodiments, the mobile device 110 may determine values for the radial distances based on the user's pattern of moving, for example using the GPS. In some cases, the mobile device 110 may include an algorithm and/or a component (e.g., a processor) that facilitates the mobile device 110 to determine a suitable radial distance to use to determine whether the mobile device 110 is within a certain area (e.g., one of areas 115a through 115c). Such an algorithm (or a component) may utilize an artificial intelligence, a machine learning, and/or a deep learning utilizing neural networks, or the like. For example, the algorithm (or the component) may learn the user's pattern of moving (e.g., moving around and/or near a reference location with a walking speed, moving between reference locations with a driving speed) and/or the user's pattern of spending time within certain boundaries of different reference locations to assist the mobile device 110 to determine the suitable radial distances.

Although in the foregoing examples, the mobile device 110 has been described and illustrated to set a user-interface parameter (e.g., the ringtone volume) to different values, in other embodiments, additional and/or alternative user-interface parameters may be set by the mobile device 110. For example, the mobile device 110 may set a vibration mode of the mobile device 110, a brightness level of a screen of the mobile device 110, a size and/or color of letters displayed on the screen, or a combination thereof, based on the environments that the mobile device 110 is situated.

FIG. 2 is an example screen 220 of a mobile device 210 that supports managing user-interface parameters in accordance with embodiments of the present technology. The mobile device 210 may be an example of or include aspects of the mobile device 110. The screen 220 of the mobile device 210 depicts two (2) ringtone volume indicators 225 (also identified individually as ringtone volume indicators 225a and 225b) for the user to provide values for a ringtone volume of the mobile device 210—e.g., one of the user-interface parameters to notify the user of an incoming call (or a text message and/or emails). For example, the user may provide a first value for the ringtone volume using a first ringtone volume indicator 225a as indicated by a position of a first circle on the first ringtone volume indicator 225a. In some cases, the user may use the first ringtone volume indicator 225a to provide a default value for the ringtone volume. Additionally, the user may provide a second value for the ringtone volume using a second ringtone volume indicator 225b as indicated by a position of a second circle on the second ringtone volume indicator 225b. In some cases, the user may use the second ringtone volume indicator 225b to provide a temporary value for the ringtone volume. As depicted in the screen 220, the default value for the ringtone volume may be set to a louder level (e.g., a high value) than the second value (e.g., a low value).

The screen 220 also includes a user-input region 230 where the user may provide one or more user-predefined conditions 235 (also identified individually as user-predefined conditions 235a through 235d) for the user-interface parameters. For example, the user-input region 230 depicted in the screen 220 is configured for the user to provide one or more user-predefined conditions 235 (and/or thresholds associated with the user-predefined conditions 235) for the ringtone volume to revert back to the first value (e.g., the default value), once the ringtone volume has been set to the second value (e.g., the temporary value). Accordingly, the one or more user-predefined conditions 235 may be regarded as conditions for the mobile device 210 having the user-interface parameter set to the second value.

In some cases, the user may provide a future date and time as the user-predefined condition 235a in the user-input region 230 such that the mobile device 210 can revert the ringtone volume to the default value when the future date and/or time arrives. For example, the mobile device 210 may revert the ringtone volume to the default value at 7 AM every day; namely, the mobile device 210 may operate with the ringtone volume set at the second value until 7 AM, next day. In some cases, the user may provide a fixed duration (e.g., three (3) hours) as the user-predefined condition 235b in the user-input region 230 such that the mobile device 210 can revert the ringtone volume to the default value when the duration (e.g., 3 hours) elapses since setting the ringtone volume to the second value; namely, the mobile device 210 may operate with the ringtone volume set at the second value for the duration.

In some cases, the user may provide a GPS location (e.g., GPS coordinates) of a reference location (e.g., the reference location 120a, the user's home) as the user-predefined condition 235c in the user-input region 230 such that the mobile device 210 can revert the ringtone volume to the default value when the mobile device 210 determines that the mobile device 210 is located in an area (e.g., the area 115a) within a radial distance (e.g., the radial distance 125a) from the reference location—e.g., when the user arrives home from a trip. That is, the mobile device 210 may operate with the ringtone volume set at the second value while the user is outside of the user's home (or the area 115a including the user's home). In some cases, the mobile device 210 may provide a drop-down menu for the user to select from, where the drop-down menu lists one or more reference locations stored in the mobile device 210, in term of their representative names (e.g., home, a movie theater, a grocery store), rather than their GPS coordinates.

In some embodiments, the user may specify an event as the user-predefined condition 235d in the user-input region 230 for the mobile device 210 to revert the user-interface parameters (e.g., the ringtone volume) to default values. For example, the user may configure the mobile device 210 to revert the ringtone volume to its default value when a predetermined quantity of calls from a particular phone number stored in the mobile device 210 is unanswered by the user—e.g., when three (3) phone calls from a doctor's office are unanswered, when five (5) calls from a family member are unanswered. The user may designate one or more phone numbers stored in the mobile device 210 (e.g., a phone number of the doctors office, a phone number of the family member) as one or more of the particular phone numbers associated with the user-predefined condition 235d. The predetermined quantity of calls may be consecutive in some cases or interspersed with other calls in other cases. In some embodiments, the mobile device 210 may elevate a current value for the user-interface parameter to a next value—e.g., increasing the ringtone volume higher (e.g., louder) from the current volume, when the predetermined quantity of calls from the particular phone number is unanswered by the user. In this manner, the mobile device 210 may mitigate a risk of incoming calls going unnoticed by the user, at least due to inadequate settings of the user-interface parameters.

In some cases, the user may specify one or more durations in a calendar application of the mobile device 210, where such durations include important future events (e.g., a funeral service for the user to attend, an extended period of stay at hospital, etc.) that the user want the mobile device 210 to maintain the user-interface parameters set to the temporary value that the user has provided—e.g., a silent mode for the ringtone volume. In such cases, even after the user-predefined condition is satisfied, the mobile device 210 may maintain the ringtone volume (e.g., the user-interface parameters) at the second value (e.g., a silence mode) when a present date and time is within the duration that the user has specified in the calendar application.

FIG. 3 is a block diagram 300 of a mobile device 310 that supports managing user-interface parameters in accordance with embodiments of the present technology. The mobile device 310 may be an example of or include aspects of the mobile devices 110 and/or 210 described with reference to FIGS. 1 and 2. The mobile device 310 may include a peripheral circuitry 315, a screen 320, and a memory 325. Further, the mobile device 310 may be coupled with a GPS 340. In some embodiments, the mobile device 310 includes an artificial intelligence (AI) component 330. The mobile device 310 can manage various user-interface parameters configured to notify a user of the mobile device 310 of incoming calls (or text messages). Such user-interface parameters may include a volume level, a vibration mode, a brightness level of the screen 320, a size of letters displayed on the screen 320, or a combination thereof.

The screen 320 may be an example of or include aspects of the screen 220 described with reference to FIG. 2. The screen 320 may be configured to perform various tasks related to interfacing with the user. In some embodiments, the screen 320 displays various indicators for the user-interface parameters—e.g., an indicator for a ringtone volume of the mobile device 310, an indicator for a vibration strength of the mobile device 310, an indicator for a brightness level of the screen 320, an indicator for a size of letters displayed on the screen 320. Based on displaying the indicators on the screen 320, the mobile device 310 may receive inputs from the user via the displayed indicators, where the user inputs are directed to values for the user-interface parameters to be set at. Further, the screen 320 may display an input region for the user to provide one or more user-predefined conditions for setting (or stopping to set) certain user-interface parameters with the values that the user provided.

For example, the screen 320 may display a ringtone volume indicator 225 described with reference to FIG. 2 such that the mobile device 310 can receive, from the user, a value for the ringtone volume, using the ringtone volume indicator 225 displayed on the screen 320. Further, the screen 320 may display the user-input region 230 described with reference to FIG. 2 such that the mobile device 310 can receive, from the user, various user-predefined conditions related to setting (or stopping to set) the ringtone volume at the value provided by the user.

The memory 325 may be configured to store a set of values for each user-interface parameter, where individual values of the set may be associated with different environments of the mobile device 310. Different environments may be based on a current location of the mobile device 310—e.g., whether the mobile device 310 is at home (e.g., the area 115a) or at a movie theater (e.g., the area 115b), a present time of a day (e.g., 9 PM on Saturday, 10 AM on Monday, etc.), or the like. In some cases, the memory 325 may store additional information related to a particular value for the user-interface parameter, such as the time and/or the day of setting the particular value for the user-interface parameter, the duration of using the particular value, or the like.

The peripheral circuitry 315 may be configured to manage one or more user-interface parameters based on various environments, in which the mobile device 310 may operate. For example, the peripheral circuitry 315 may determine whether a user-interface parameter (e.g., the ringtone volume) is set to an appropriate value (e.g., a high volume, a low volume) that has been provided (and/or used) by the user, by monitoring various user-predefined conditions. In some cases, the peripheral circuitry 315 may set the user-interface parameter (e.g., the ringtone volume) to a different value (e.g., the high volume) from a current value (e.g., the low volume), after determining that a user-predefined condition satisfies a threshold. In other cases, the mobile device may notify the user that the user-predefined condition has satisfied the threshold and/or prompt the user to confirm setting the user-interface parameter to the different value (e.g., the high volume).

In some embodiments, the peripheral circuitry 315 may store, in the memory 325, a first value for the user-interface parameter provided by the user. Subsequently, the peripheral circuitry 315 may set the user-interface parameter to a second value provided by the user, where the second value is different from the first value. The peripheral circuitry 315 may determine, after setting the user-interface parameter to the second value, that a user-predefined condition satisfies a threshold, and set the user-interface parameter to a third value in response to determining that the user-predefined condition has satisfied the threshold. In some cases, the third value may correspond to the first value. In other cases, the third value may correspond to the second value if the user prefers to have the mobile device 310 to operate with the user-interface parameter set at the second value. In some cases, the third value may be different from both the first value and the second value. Further, the peripheral circuitry 315 may notify the user that the user-interface parameter is set to the third value and/or that the user-predefined condition has satisfied the threshold.

In some embodiments, the user-predefined condition includes a distance between a present location of the mobile device 310 determined by the GPS 340 coupled with the mobile device 310 and a reference location stored in the memory 325, an elapsed duration since setting the user-interface parameter to the first value, a predetermined quantity of calls from a particular phone number stored in the mobile device, a present time of a day, or a combination thereof. Further, the first value may be associated with a first area within a first radial distance from a first reference location stored in the memory 325, and the second value may be associated with a second area within a second radial distance from a second reference location stored in the memory 325.

In some cases, the user may provide the radial distances for the peripheral circuitry 315 to use in determining whether the mobile device 310 is within the first area or the second area. In some cases, the peripheral circuitry 315 determines a suitable radial distance based on the user's pattern of usage as described with reference to FIG. 1. In some embodiments, the AI component 330 may assist the peripheral circuitry 315 to determine the suitable radial distance to use, based on the user's pattern of moving and/or the user's pattern of spending time within different areas (e.g., the areas 115a through 115c). The AI component 330 may be configured to carry out an algorithm to learn the user's pattern of using different values for the user-interface parameters under different environments and/or the user's pattern of specifying different conditions for the user-predefined conditions. The AI component 330 may be based on a machine learning scheme, and/or include a deep learning component (e.g., a processor utilizing neural networks), or the like.

FIG. 4 is a flowchart 400 illustrating a method of managing user-interface parameters for mobile devices in accordance with embodiments of the present technology. The flowchart 400 may be an example of or include aspects of a method that a mobile device (e.g., the mobile device 110, the mobile device 210, the mobile device 310) may perform as described with reference to FIGS. 1 through 3.

The method includes storing, in a memory of the mobile device, a first value for a user-interface parameter of the mobile device provided by a user of the mobile device, where the user-interface parameter is configured to notify an incoming call to the user (box 410). In accordance with one aspect of the present technology, the storing feature of box 410 can be performed by the mobile device, in conjunction with the peripheral circuitry 315 and/or the memory 325 in some cases, as described with reference to FIGS. 1 through 3.

The method further includes setting the user-interface parameter to a second value provided by the user, where the second value is different from the first value (box 415). In accordance with one aspect of the present technology, the setting feature of box 415 can be performed by the mobile device, in conjunction with the peripheral circuitry 315 in some cases, as described with reference to FIGS. 1 through 3.

The method further includes determining, after setting the user-interface parameter to the second value, that a user-predefined condition satisfies a threshold (box 420). In accordance with one aspect of the present technology, the determining feature of box 420 can be performed by the mobile device, in conjunction with the peripheral circuitry 315 in some cases, as described with reference to FIGS. 1 through 3.

The method further includes setting the user-interface parameter to a third value in response to determining that the user-predefined condition has satisfied the threshold (box 425). In accordance with one aspect of the present technology, the setting feature of box 425 can be performed by the mobile device, in conjunction with the peripheral circuitry 315 in some cases, as described with reference to FIGS. 1 through 3.

In some embodiments, the user-interface parameter comprises a volume level of the mobile device, a vibration mode of the mobile device, a brightness level of a screen of the mobile device, or a combination thereof. In some embodiments, the third value is equal to the first value. In some embodiments, the third value differs from both the first value and the second value. In some embodiments, the third value is equal to the second value, and the method may further include notifying the user that the user-predefined condition has satisfied the threshold. In some embodiments, the third value is equal to the second value when a present date and time is within a duration that the user has specified in a calendar application of the mobile device.

In some embodiments, the user-predefined condition comprises a distance between a present location determined by a global positioning system (GPS) coupled with the mobile device and a reference location stored in the mobile device, an elapsed duration since setting the user-interface parameter to the first value, a predetermined quantity of calls from a particular phone number stored in the mobile device, a present future time of a day, or a combination thereof. In some embodiments, the first value is associated with a first area within a first radial distance from a first reference location stored in the mobile device, and the second value is associated with a second area within a second radial distance from a second reference location stored in the mobile device.

In some embodiments, the method may further include notifying the user that the user-interface parameter is set to the third value and that the user-predefined condition has satisfied the threshold. In some embodiments, notifying the user further comprises generating a verbal message using the mobile device, the verbal message directed to setting the user-interface parameter set to the third value, transmitting a text message to the mobile device, the text message directed to setting the user-interface parameter to the third value, displaying a pop-up window on a screen of the mobile device, the pop-up window including information directed to setting the user-interface parameter to the third value, or a combination thereof.

FIG. 5 is a flowchart 500 illustrating a method of managing user-interface parameters for mobile devices in accordance with embodiments of the present technology. The flowchart 500 may be an example of or include aspects of a method that a mobile device (e.g., the mobile device 110, the mobile device 210, the mobile device 310) may perform as described with reference to FIGS. 1 through 3.

The method includes storing, in a memory of the mobile device, a first value for a user-interface parameter of the mobile device provided by a user of the mobile device and associated with a first reference location stored in the mobile device (box 510). In accordance with one aspect of the present technology, the storing feature of box 510 can be performed by the mobile device, in conjunction with the peripheral circuitry 315 and/or the memory 325 in some cases, as described with reference to FIGS. 1 through 3.

The method further includes determining that the mobile device is in a first area within a first radial distance from the first reference location based on a present location of the mobile device determined by a GPS coupled with the mobile device (box 515). In accordance with one aspect of the present technology, the determining feature of box 515 can be performed by the mobile device, in conjunction with the peripheral circuitry 315 in some cases, as described with reference to FIGS. 1 through 3.

The method further includes setting the user-interface parameter to the first value based on determining that the mobile device is in the first area (box 520). In accordance with one aspect of the present technology, the setting feature of box 520 can be performed by the mobile device, in conjunction with the peripheral circuitry 315 in some cases, as described with reference to FIGS. 1 through 3.

In some embodiments, the method may further include prompting the user, prior to setting the user-interface parameter to the first value, whether to set the user-interface parameter to the first value, based on determining that the mobile device is in the first area. In some embodiments, the method may further include determining, prior to prompting the user, that the user-interface parameter has been set to a second value different than the first value, where the second value has been provided by the user and associated with a second reference location stored in the mobile device. In some embodiments, the method may further include notifying, prior to prompting the user, the user that the mobile device is in the first area based on determining that the mobile device is in the first area, and that the first condition value is available for the user-interface parameter. In some embodiments, the method may further include determining, after setting the user-interface parameter to the first value, that the mobile device is moved to a third location different from the present location, determining that the user has set the user-interface parameter to a third value different from the first value, and storing the third value and the third location in the memory.

It should be noted that the methods described above describe possible implementations, and that the operations and the steps may be rearranged or otherwise modified and that other implementations are possible. Furthermore, embodiments from two or more of the methods may be combined.

The functions described herein may be implemented in hardware, software executed by a processor, firmware, or any combination thereof. Other examples and implementations are within the scope of the disclosure and appended claims. Features implementing functions may also be physically located at various positions, including being distributed such that portions of functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing, it will be appreciated that specific embodiments of the invention have been described herein for purposes of illustration, but that various modifications may be made without deviating from the scope of the invention. Rather, in the foregoing description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the technology. In general, it should be understood that various other devices, systems, and methods in addition to those specific embodiments disclosed herein may be within the scope of the present technology.

What is claimed is:

1. A method, comprising:
storing, in a memory of a mobile device, a first value for a user-interface parameter of the mobile device provided by a user of the mobile device, wherein the user-interface parameter is configured to notify an incoming call to the user;
setting the user-interface parameter to a second value provided by the user, wherein the second value is different from the first value;
determining, after setting the user-interface parameter to the second value, that a user-predefined condition that is based at least in part on a geolocation of the mobile device or an elapsed time for an operating condition of the mobile device, or both, satisfies a threshold; and
setting the user-interface parameter to a third value in response to determining that the user-predefined condition has satisfied the threshold.

2. The method of claim 1, wherein the user-predefined condition comprises a distance between a present location determined by a global positioning system (GPS) coupled with the mobile device and a reference location stored in the mobile device, an elapsed duration since setting the user-interface parameter to the first value, a predetermined quantity of calls from a particular phone number stored in the mobile device, a future time of a day, or a combination thereof.

3. The method of claim 1, wherein the first value is associated with a first area within a first radial distance from a first reference location stored in the mobile device, and wherein the second value is associated with a second area within a second radial distance from a second reference location stored in the mobile device.

4. The method of claim 1, wherein the user-interface parameter comprises a volume level of the mobile device, a vibration mode of the mobile device, a brightness level of a screen of the mobile device, or a combination thereof.

5. The method of claim 1, wherein the third value is equal to the first value.

6. The method of claim 1, wherein the third value differs from both the first value and the second value.

7. The method of claim 1, wherein the third value is equal to the second value, and the method further comprises notifying the user that the user-predefined condition has satisfied the threshold.

8. The method of claim 1, wherein the third value is equal to the second value when a present date and time is within a duration that the user has specified in a calendar application of the mobile device.

9. The method of claim 1, further comprising:
notifying the user that the user-interface parameter is set to the third value and that the user-predefined condition has satisfied the threshold.

10. The method of claim 9, wherein notifying the user further comprises:
generating a verbal message using the mobile device, the verbal message directed to setting the user-interface parameter set to the third value;
transmitting a text message to the mobile device, the text message directed to setting the user-interface parameter to the third value;
displaying a pop-up window on a screen of the mobile device, the pop-up window including information directed to setting the user-interface parameter to the third value; or
a combination thereof.

11. A method, comprising:
storing, in a memory of a mobile device, a first value for a user-interface parameter of the mobile device provided by a user of the mobile device and associated with a first reference location stored in the mobile device;
determining that the mobile device is in a first area within a first radial distance from the first reference location based on a present location of the mobile device determined by a global positioning system (GPS) coupled with the mobile device; and
setting the user-interface parameter to the first value based on determining that the mobile device is in the first area.

12. The method of claim 11, further comprising:
prompting the user, prior to setting the user-interface parameter to the first value, whether to set the user-interface parameter to the first value, based on determining that the mobile device is in the first area.

13. The method of claim 12, further comprising:
determining, prior to prompting the user, that the user-interface parameter has been set to a second value different than the first value, wherein the second value has been provided by the user and associated with a second reference location stored in the mobile device.

14. The method of claim 12, further comprising:
notifying, prior to prompting the user, the user that the mobile device is in the first area based on determining that the mobile device is in the first area, and that the first value is available for the user-interface parameter.

15. The method of claim 11, further comprising:
determining, after setting the user-interface parameter to the first value, that the mobile device is moved to a third location different from the present location;
determining that the user has set the user-interface parameter to a third value different from the first value; and
storing the third value and the third location in the memory.

16. An apparatus, comprising:
a screen;
a memory to store a plurality of values for a user-interface parameter of the apparatus, wherein the user-interface parameter is configured to notify an incoming call to a user of the apparatus; and
peripheral circuitry configured to:
store, in the memory, a first value for the user-interface parameter provided by the user;
set the user-interface parameter to a second value provided by the user, wherein the second value is different from the first value;
determine, after setting the user-interface parameter to the second value, that a user-predefined condition satisfies a threshold; and
set the user-interface parameter to a third value in response to determining that the user-predefined condition that is based at least in part on a geolocation of the apparatus or an elapsed time for an operating condition of the apparatus, or both, has satisfied the threshold.

17. The apparatus of claim 16, wherein the user-interface parameter comprises a volume level of the apparatus, a vibration mode of the apparatus, a brightness level of a screen of the apparatus, or a combination thereof.

18. The apparatus of claim 16, wherein the user-predefined condition comprises a distance between a present location of the apparatus determined by a global positioning system (GPS) coupled with the apparatus and a reference location stored in the memory, an elapsed duration since setting the user-interface parameter to the first value, a predetermined quantity of calls from a particular phone number stored in the apparatus, a present time of a day, or a combination thereof.

19. The apparatus of claim 16, wherein the first value is associated with a first area within a first radial distance from a first reference location stored in the memory, and wherein the second value is associated with a second area within a second radial distance from a second reference location stored in the memory.

20. The apparatus of claim 16, wherein the peripheral circuitry is further configured to:
notify the user that the user-interface parameter is set to the third value and that the user-predefined condition has satisfied the threshold.
